(19) United States
(12) Patent Application Publication
(10) Pub. No.: US 2013/0156150 A1
(43) Pub. Date: Jun. 20, 2013

(54) RADIATION TOMOGRAPHY APPARATUS

(71) Applicant: SHIMADZU CORPORATION, Kyoto-shi (JP)

(72) Inventor: Hiromichi TONAMI, Kyoto-shi (JP)

(73) Assignee: SHIMADZU CORPORATION, Kyoto-shi (JP)

(21) Appl. No.: 13/720,326

(22) Filed: Dec. 19, 2012

(30) Foreign Application Priority Data
Dec. 19, 2011 (JP) 2011-277372

(51) Int. Cl. G01N 23/04

(52) U.S. Cl. CPC G01N 23/046
USPC 378/9; 378/20

(57) ABSTRACT

A radiation tomography apparatus comprising a first imaging device for taking tomography images of a subject by introducing the subject in an introduction direction of the subject, a support member for supporting the subject, a support-member moving device for moving the support member in the introduction direction of the subject, a support-member movement controller for controlling the support-member moving device, a first cylinder provided in a first imaging view field of the first imaging device and having an opening extending in the introduction direction for introducing the support member and a first positioning device for positioning the first cylinder relative to the first imaging view field, the first cylinder guiding the movable support member.

### BACKGROUND OF THE INVENTION

This invention relates to a radiation tomography apparatus that images a subject. Particularly, this invention is directed to a radiation tomography apparatus for inspecting smaller animals.

### BACKGROUND ART

A radiation tomography apparatus has been known as one example of an apparatus for imaging a subject as an object to be inspected. The apparatus can generate tomography images of the subject, to which an operator refers to recognize an internal subject structure. See, for example, WO2007/141831.

Now, description will be given of a configuration in such radiation tomography apparatus. As shown in FIG. 14, the conventional apparatus includes a gantry 51 with an opening. Inside of the gantry 51, a radiation source 53 for emitting radiation and a radiation detector 54 for detecting the radiation are provided. The radiation source 53 and the radiation detector 54 are arranged across the opening of the gantry 51. They can rotate around the opening while a relationship therebetween being maintained. A subject is placed within the opening.

Next, description will be given of operation of the conventional radiation tomography apparatus. In order to obtain tomography images of the subject with the conventional apparatus, the subject is firstly inserted into the opening of the gantry 51. Then radiography is conducted two or more times while the radiation source 53 and the radiation detector 54 rotate around the subject. The obtained fluoroscopic images each contain an image of the subject having different imaging directions. Constructing these fluoroscopic images can generate a tomography image of the subject.

The conventional radiation tomography apparatus includes a cylinder 59 inside of the gantry 51. Description will be given next of the cylinder 59. The cylinder 59 is cylindrical that conforms to the shape of the inner wall of the opening of the gantry 51, and is inserted into the opening. The subject is to be introduced into the inside of the cylinder 59. The cylinder 59 suppresses escape of the subject into the apparatus or entering of excrement or urine of the subject into the apparatus.

Description will be given next of a moving mechanism for the subject. The conventional apparatus includes a support member 52 for introducing the subject into the gantry 51. The support member 52 is movable in a direction where the opening extends in the gantry 51.

### SUMMARY

The conventional construction, however, has the following problem. Specifically, the problem arises that the conventional configuration has difficulty in moving the subject accurately.

The subject has a length longer than an imaging view field of the apparatus, which leads to impossibility for the apparatus to take images of the subject at one time. Consequently, the subject is to be moved during radiography. Thus imaging results of the subject in every position are composed upon generating a tomography image. The support member 52 is used for such movement of the subject.

The support member 52 is elongate. Thus, as the support member 52 extends inside of the gantry 51 through introducing the subject into the apparatus, the support member 52 gradually bends downward accordingly. That is, a position of the subject in the vertical direction at the beginning of the radiography differs from that at the end of radiography. Conducting radiography for the subject with the different positions causes composition of the images of the subject while they deviate in the vertical direction. As a result, the image of the subject is distorted.

This invention has been made regarding the state of the art noted above, and its object is to provide a radiation tomography apparatus capable of obtaining a clear tomography image.

This invention is constituted as stated below to achieve the above object. This invention discloses a radiation tomography apparatus that includes a first imaging device for taking tomography images of a subject by introducing the subject in an introduction direction of the subject; a support member for supporting the subject; a support-member moving device for moving the support member in the introduction direction of the subject; a support-member movement controller for controlling the support-member moving device; a first cylinder provided in a first imaging view field of the first imaging device and having an opening extending in the introduction direction for introducing the support member; and a first positioning device for positioning the first cylinder relative to the first imaging view field. The first cylinder guides the movable support member.

### Operation and Effect

This invention includes the first cylinder having the opening for introducing the support member, the first positioning device for positioning the first cylinder, and the support member guided in the first cylinder for supporting the subject movable relative to the first cylinder. Such configuration causes the support member to support while guide the subject. Accordingly, the subject during the movement always has a constant position in the vertical direction. In other words, according to the configuration of this invention, no deviation in position of the subject occurs during radiography and thus tomography images can be provided with high visibility and no distortion.

Moreover, the first cylinder also serves to prevent the subject from escaping into the apparatus or to prevent excrement of the subject from entering into the apparatus. Consequently, this invention can provide a radiation tomography apparatus with less failure.

The aforementioned radiation tomography apparatus further includes a second imaging device provided adjacent to the first imaging device in the introduction direction for taking tomography images of the subject by introducing the subject in the introduction direction; a second cylinder provided in a second imaging view field of the second imaging device and having an opening extending in the introduction direction for introducing the support member; and a second positioning device for positioning the second cylinder relative to the second imaging view field. The second cylinder guides the movable support member. Such configuration is more desirable.

### Operation and Effect

The above is a configuration where this invention is applied to the apparatus having two types of radiation tomography apparatus. Examples of such apparatus include a PET/CT apparatus. The foregoing configuration includes the second cylinder having the opening for introducing the support member and the second positioning device for positioning the second cylinder. In such configuration, the second cylinder guides the support member. According to such configuration, no deviation in position of the subject occurs during radiography using any tomography apparatus, and thus tomography images can be provided with high visibility and no distortion. Moreover, the second cylinder also serves to prevent the subject from escaping into the apparatus or to prevent excrement of the subject from entering into the apparatus. Consequently, this invention can provide a radiation tomography apparatus with less failure.

Moreover, in the aforementioned radiation tomography apparatus, a position of the cylinder relative to the imaging view field is adjusted by a jig. Such configuration is more desirable.

### Operation and Effect

The aforementioned configuration is one example of the radiation tomography apparatus according to this invention. When the position of the cylinder relative to the imaging view field is adjusted by the jig, the subject can be moved accurately with no deviation in position thereof.

The positioning device of the aforementioned radiation tomography apparatus is formed of screws. Such configuration is more desirable.

### Operation and Effect

The aforementioned configuration is one example of the radiation tomography apparatus according to this invention. The positioning device formed of the screws can achieve positional adjustment with higher accuracy.

The cylinder of the aforementioned radiation tomography apparatus has a rail on an inner wall thereof that contacts the support member and extends in the introduction direction.

### Operation and Effect

The aforementioned configuration is one example of the radiation tomography apparatus according to this invention. The rail extending in the introduction direction is provided on the inner wall of the cylinder for contacting the support member. Thereby the support member can be moved on a given track with higher accuracy. The configuration using the rail may cause wear of a portion of the support member where the rail is contacted. In this case, however, the position of the cylinder can also be adjusted finely with use of the positioning device. Thereby no particular problem occurs.

Moreover, in the aforementioned radiation tomography apparatus, the cylinder has a ring-shaped flange on one end thereof. Such configuration is more desirable.

### Operation and Effect

The aforementioned configuration is one example of the radiation tomography apparatus according to this invention. The ring-shaped flange on one end of the cylinder can be used for determination in position of the cylinder. Consequently, the aforementioned configuration can complete positioning of the cylinder simpler.

Moreover, the first imaging device of the aforementioned radiation tomography apparatus includes a radiation source for emitting radiation, a detecting device for detecting the radiation, and a radiation-source control device for controlling the radiation source. Such configuration is more desirable.

### Operation and Effect

The aforementioned configuration is one example of the radiation tomography apparatus according to this invention. As above, this invention is applicable to a CT apparatus.

Moreover, the second imaging device of the aforementioned radiation tomography apparatus includes a detector ring having radiation detectors being arranged in a ring shape. Such configuration is more desirable.

### Operation and Effect

The aforementioned configuration is one example of the radiation tomography apparatus according to this invention. As above, this invention is applicable to a PET/CT apparatus.

This invention includes a first cylinder; a first positioning device; and a support member. The first cylinder has an opening for introducing the support member. The first positioning device positions the first cylinder. The support member is guided by the first cylinder and supports the movable subject relative to the first cylinder. According to such configuration, no deviation in position of the subject occurs during radiography and thus tomography images can be produced with high visibility and no distortion. Moreover, the first cylinder also serves to prevent the subject from escaping into the apparatus or to prevent excrement of the subject from entering into the apparatus. Consequently, this invention can provide a radiation tomography apparatus with less failure.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a functional block diagram showing an overall configuration of a tomography X-ray apparatus according to one example of this invention.

FIG. 2 is a perspective view showing a configuration of a first cylinder according to the example of this invention.

FIG. 3 is a plan view showing the first cylinder according to the example of this invention.

FIG. 4 is an exploded perspective view showing a configuration of a screw according to the example of this invention.

FIG. 5 is an explanatory view of a jig according to the example of this invention.

FIG. 6 is a perspective view showing a method of using the jig according to the example of this invention.

FIG. 7 is a plan view showing the method of using the jig according to the example of this invention.

FIG. 8 is a schematic view showing rotation of an X-ray tube and an FPD according to the example of this invention.

FIG. 9 is a plan view showing a holder according to the example of this invention.

FIG. 10 is a sectional view showing operations of the radiation tomography apparatus according to Embodiment 1.

FIG. 11 is a functional block diagram showing an overall configuration of a tomographic X-ray apparatus according to another example of this invention.

FIG. 12 is a perspective view showing one modification according to one modification of this invention.

FIG. 13 is a sectional view showing the modification of this invention.

FIG. 14 is a sectional view of a conventional radiation tomography apparatus.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

### Example 1

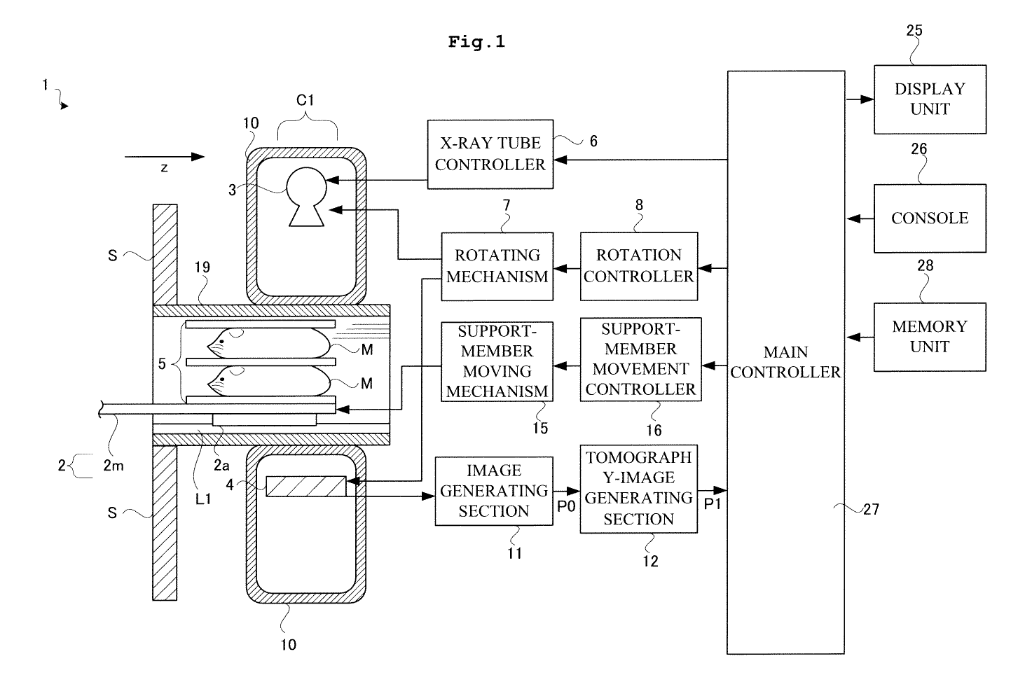

Description will be given first of a tomographic X-ray apparatus according to Example 1. As shown in FIG. 1, a fluoroscopic X-ray apparatus 1 includes a support member 2 for supporting a subject M placed thereon, and a gantry 10 with a through hole in a direction where the support member 2 extends. The support member 2 is inserted into the through hole of the gantry 10. The support member 2 can move forward and backward in the direction where the support member 2 extends (i.e., an orthogonal direction of an imaginary circle VC to be mentioned later: a z-direction) relative to a support board S. The support member 2 is moved by a support-member moving mechanism 15. The support-member moving mechanism 15 is controlled by a support-member movement controller 16. Here, the support-member moving mechanism 15 corresponds to the support-member moving device in this invention. The support-member movement controller 16 corresponds to the support-member movement control device in this invention.

Description will be given of the support member 2. The support member 2 supports the subject M via a holder 5. The support member 2 is guided by a first rail L1 and is movable in the z-direction (an introduction direction of the subject M) relative to a first cylinder 19. As the support member 2 is moved, the subject M is moved forward and backward in the z-direction relative to the body of the apparatus. As shown in FIG. 1, the support member 2 has an arm 2m extending in the z-direction and a rail receiver 2a contacting to the first rail L1.

Description will be given next of the rail receiver 2a. The rail receiver 2a is fixed on the arm 2m, and has a groove in the z-direction that engages the first rail L1. See FIG. 3. Accordingly, the rail receiver 2a moves in the z-direction while engaging on the first rail L1. The rail receiver 2a has a track defined by the first rail L1. The support member 2 is moved in the z-direction relative to the first rail L1 as the rail receiver 2a moves.

<Regarding First Cylinder>

Description will be given next of the first cylinder 19 inserted into an opening of the gantry 10. The first cylinder 19 is a cylindrical member that is provided within the gantry 10 and extends in the z-direction, as shown in FIG. 1. The first cylinder 19 is arranged in a first imaging view field of a first imaging section C1, and has the opening for introducing the support member that extends in the z-direction. The subject M is introduced into the first cylinder 19 upon radiography. The first cylinder 19 is provided for preventing the subject M from escaping into the apparatus or for preventing excrement of the subject M from entering into the apparatus. The first cylinder 19 is fixed by the support board S for supporting the first cylinder 19. The support board S is positioned adjacent to the gantry 10 in the z-direction. Here, the first imaging section C1 corresponds to the first imaging device in this invention.

The first cylinder 19 has another role other than prevention of the subject M from escaping. That is, the cylinder 19 also serves as a guide for supporting the subject M upon movement of the support member 2. Specifically, the cylinder 19 has the first rail L1 on an inner wall thereof that contacts the support member 2 and extends in the z-direction. Consequently, the support member 2 is moved while being guided by the first cylinder 19.

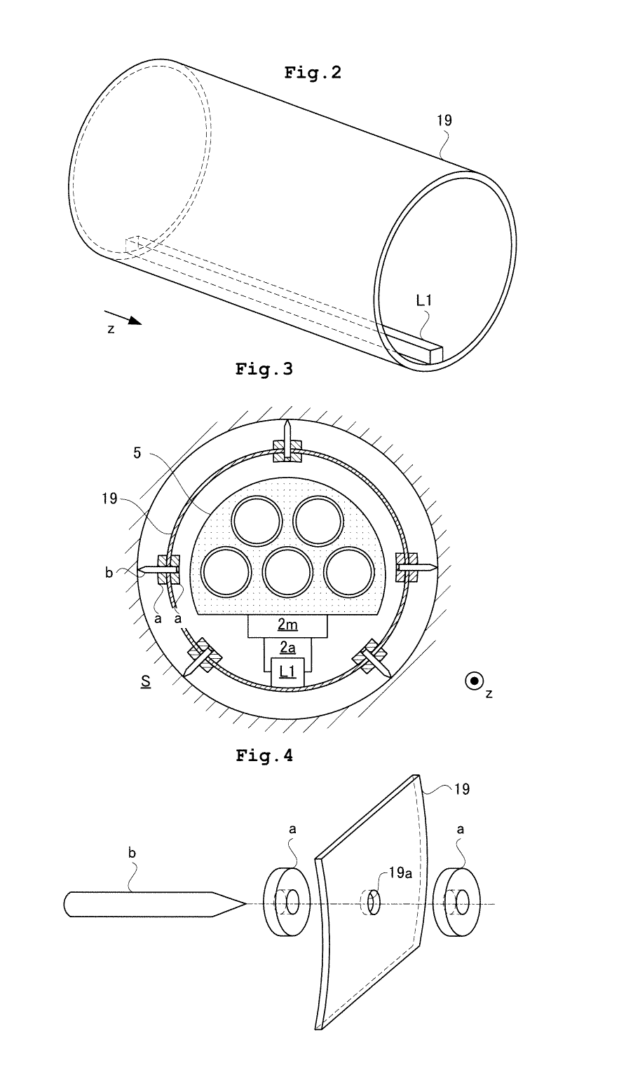

Description will be given next of the first cylinder 19. The first cylinder 19 is cylindrical having the first rail L1 on the bottom of the inner wall thereof, as shown in FIG. 2. The first cylinder 19 is composed of an acrylic resin, etc., that is easy to transmit X-rays. FIG. 3 shows the first cylinder 19 supported by the support board S. The support board S is provided with a circular opening that extends in the z-direction, into which the first cylinder 19 is inserted. The first cylinder 19 has screws b for contacting to the inner wall of the opening of the support board S. These screws b are provided at five different positions on the section of the first cylinder 19. The first cylinder 19 is fixedly supported on the support board S via the screws b. The screws b are inserted from inside toward outside of the first cylinder 19. The screws b correspond to the positioning device in this invention.

FIG. 4 shows in more detail the screw b. The first cylinder 19 has holes 19a through which the screws b pass. Two reinforcement members “a” in a ring shape are adhered to the first cylinder 19 across the hole 19a. An inner hole is generated through connecting an inner hole of one reinforcement member “a”, the hole 19a, and an inner hole of the other reinforcement member “a”, and the screw b is inserted into the generated inner hole. Description will be given of the reason for such configuration. Since it is necessary to transmit X-rays emitted from the X-ray tube 3, the first cylinder 19 is thin. When the screws b are inserted into the thin first cylinder 19, the first cylinder 19 cannot support the screws b satisfactorily. As a result, the screws b may be unstable relative to the first cylinder 19. Accordingly, the reinforcement members “a” are provided so as to extend the hole 19a into a direction where the screw b is inserted. The reinforcement members “a” can achieve rigid support of the screw b relative to the first cylinder 19. Here, the X-ray tube 3 corresponds to the radiation source in this invention.

The screw b is threaded. The inner holes of the reinforcement members “a” and the hole 19a are screw holes. Consequently, when the screws b rotate, they project from and retract into the first cylinder 19. A tip end of the screw b is sharp, and the tip contacts to the support board S. Thereby rotation of the screw b can adjust a positional relationship between the support board S and the first cylinder 19. As above, the screw b positions the first cylinder 19 relative to the first imaging section C1. Incidentally, in FIG. 3, the holder for supporting the subject M placed thereon is denoted by the symbol 5.

<Method of Positioning First Cylinder>

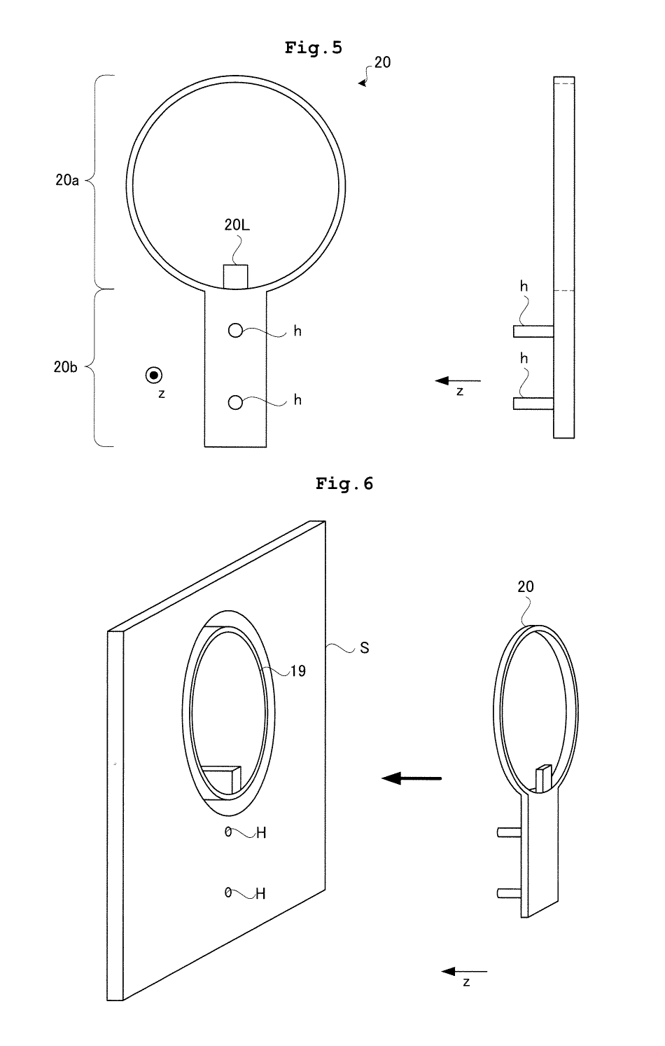

Description will be given next of positioning the first cylinder 19 relative to the support board S. The first cylinder 19 is fixed on the support board S using a jig 20 shown in FIG. 5. FIG. 5 has a plan view of the jig 20 seen in the z-direction on the left side, and a plan view of the jig 20 seen from the side on the right side.

The jig 20 has two portions, i.e., a cylindrical portion 20a in a ring shape and an elongated contacting portion 20b that contacts to the support board S. The cylindrical portion 20a has a shape along the contour of the first cylinder 19. The cylindrical portion 20a has a diameter and a thickness equal to the first cylinder 19. The contacting portion 20b has an elongated shape extending in a direction away from the cylindrical portion 20a. The contacting portion 20b includes two dowel pins h projecting in the z-direction. The dowel pins h are arranged in a direction where the contacting portion 20b extends.

The cylinder portion 20a of the jig 20 is provided with a projection 20L projecting toward the center of the cylinder. The projection L has a shape following that of the first rail L. That is, the shape of the projection L is same as that of the first rail L in the z-direction.

FIG. 6 shows how to fix the first cylinder 19 to the support board S using the jig 20. Firstly, the extent of projecting the screws b is adjusted such that the first cylinder 19 can be housed into the opening of the support board S, and then the first cylinder 19 is housed into the opening of the support board S. Here, the screws b is loosely fixed, and thus the first cylinder 19 can be moved inside the opening. In this state, the jig 20 is fixed to the support board S in a direction where the first cylinder 19 is inserted. Here, the jig 20 contacts to a plane of the support board S orthogonal to the z-direction. The support board S is also provided with dowel holes H into which the dowel pins h are inserted. The dowel pins h are inserted into the dowel holes H, whereby the positional relationship between the support board S and the jig 20 is determined uniquely.

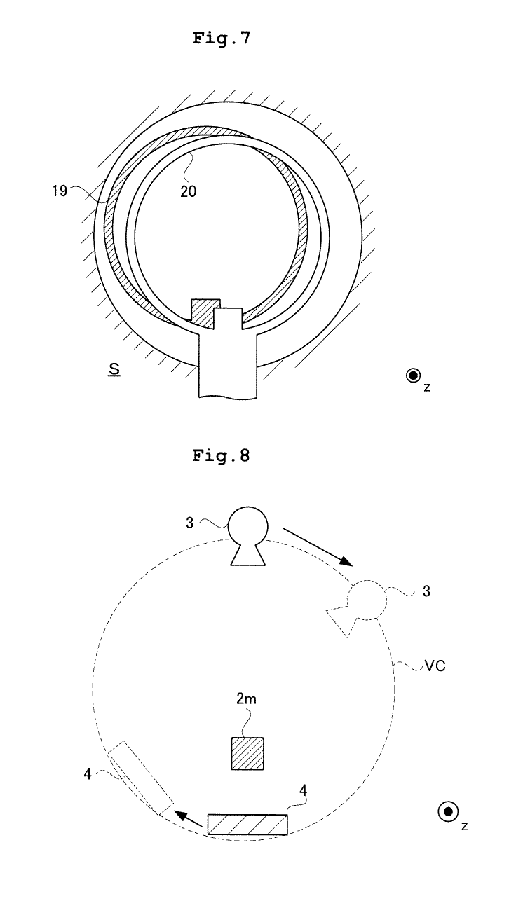

FIG. 7 shows adjustment of the position of the first cylinder 19 using the jig 20. The cylindrical portion 20a of the jig 20 has a shape formed along the contour of the first cylinder 19. Consequently, when the jig 20 is seen in the z-direction, the first cylinder 19 having the same shape as the cylindrical portion 20a can be seen behind the jig 20. An operator moves the first cylinder 19 up to a position where it overlaps the cylindrical portion 20a seen from the z-direction, and then projecting each screw b to fix the first cylinder 19 to the support board S. As above, the positional relationship between the first cylinder 19 and the support board S is determined uniquely via the jig 20.

Especially, the position of the first rail L should be determined precisely relative to the support board S. That is because deviation of the first rail L1 from the support board S causes deviation of the track on which the support member 2 moves from the first imaging view field. The operator can adjust the first rail L1 while observing the projection 20L of the jig 20. In other words, when the first rail L1 is in a given position relative to the support board S, the projection 20L completely overlaps the first rail L1 seen from the z-direction.

<Regarding Other End of First Cylinder>

The above only describes one of both ends of the first cylinder 19. Then description will be given of the other end of the first cylinder 19 having not been described yet. The other end corresponds to one ends of the first cylinder 19 on a gantry 10 side. It is referred to as a gantry-side end. The gantry-side end is supported by the gantry 10 via the screws b, which is similar to the configuration described with reference to FIG. 3.

Description will be given of positioning at the gantry-side end. This positioning is performed using the jig 20. Specifically, the gantry 10 is provided with the dowel holes through which the dowel pins h are inserted when the jig 20 is used. The detailed approach of actual positioning has been already described with reference to FIGS. 6 and 7.

<Other Components of Radiation Tomography Apparatus>

Description will be given next of the other components of the radiation tomography apparatus according to Example 1. The gantry 10 includes inside thereof an X-ray tube 3 for emitting X-rays, and an FPD 4 for detecting the X-rays. X-rays from the X-ray tube 3 pass across a through hole of the gantry to reach the FPD 4. Here, the X-ray tube 3 corresponds to the radiation source in this invention. The FPD 4 corresponds to the radiation-detecting device in this invention. X-ray tube 3 and the FPD 4 form an imaging system that takes X-ray images. They are referred to as a first imaging section C1.

An X-ray tube controller 6 is provided for controlling the X-ray tube 3 with a given tube current, a tube voltage, and a pulse width. The FPD 4 detects X-rays emitted from the X-ray tube 3 and transmitting through the subject M, and generates detection signals. The detection signals are sent out to an image generating section 11, where a fluoroscopic image P0 is generated having a projected image of the subject M containing therein. A tomography-image generating section 12 generates a tomography image P1 taken upon cutting the subject M by an any slice plane in accordance with the fluoroscopic image P0 generated by the image generating 11. The X-ray tube controller 6 corresponds to the radiation source control device in this invention.

Description will be given of rotation of the X-ray tube 3 and the FPD 4. The X-ray tube 3 and the FPD 4 are rotated integrally by a rotating mechanism 7 about a central axis in a direction where the arm 2m forming the support member 2 extends. More specifically, as shown in FIG. 8, the X-ray tube 3 and the FPD 4 move and rotate while a relative positional relationship therebetween is maintained. Herein, the rotating mechanism 7 rotates the X-ray tube 3 along an imaginary circle VC having a center as a midpoint on a line connecting the X-ray tube 3 and the FPD 4. A direction orthogonal to the imaginary circle VC (i.e., a direction passing through the plane of FIG. 8: z-direction) conforms to the direction where the arm 2m extends. A rotation controller 8 is provided for controlling the rotating mechanism 7.

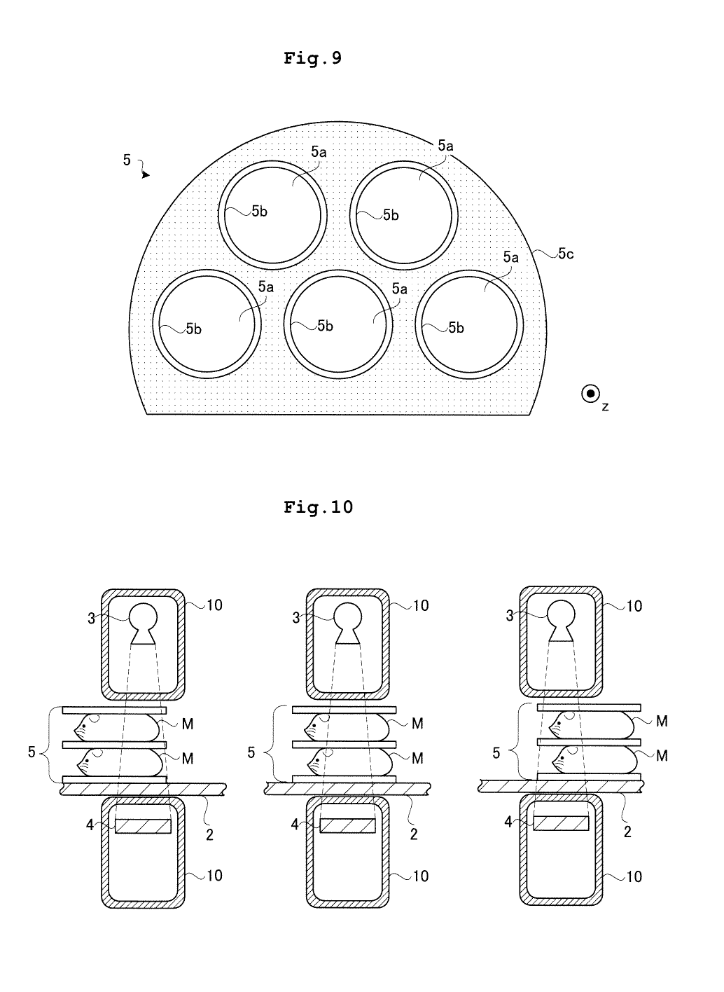

The arm 2m has the holder 5 placed thereon for holding the subject M. Description will be given of the configuration of the holder 5. As shown in FIG. 9, the holder 5 includes five openings 5a in a circular shape, the circular being cylindrical extending in the z-direction when considered as a three-dimensional object. Each one subject M is inserted into every opening 5a. A cylinder 5b forms an inner wall of the opening 5a. The cylinder 5b is embedded in each through hole for support in a Styrofoam cylindrical support member 5d having two or more holes opened in a lotus shape in the z-direction. Moreover, the cylinder 5b is composed of an acrylic resin easy to transmit X-rays. The holder 5 has three openings 5a on a first step on a near side to the arm 2m, and two openings 5a on a second step on a far side from the arm 2m.

A display unit 25 is provided for displaying the tomography image P1 obtained through radiography. A console 26 is provided for inputting experimenter's instructions such as start of emitting X-rays. A main controller 27 is also provided for controlling each controller en bloc. The main controller 27 has a CPU, and executes each controller 6, 8, 16 and each section 11, 12 by executing various programs. The above components may be divided into arithmetic units that perform their functions. A memory unit 28 memorizes all parameters with respect to control of the X-ray tomography apparatus 1 such as parameters used for imaging.

<Operation of Radiation Tomography Apparatus>

Next, description will be given of operations of the X-ray tomography apparatus 1. Prior to radiography, the subjects M are under anesthesia so as not to move during radiography. Each of the anesthetized subjects M is housed into the opening 5a of the holder 5. Herein, one subject M is housed per one opening 5a of the holder 5. Since the holder 5 is provided with five openings 5a, five subjects M can be housed in the holder 5. The holder 5 having two or more subjects M housed therein is placed on the support member 2.

Upon an operator provides instructions via the console 26 to start imaging, an X-ray tube controller 6 emits X-rays intermittently in accordance with an irradiation time, a tube current, and a tube voltage stored in the memory 28. Meanwhile, the rotating mechanism 7 rotates the X-ray tube 3 and the FPD 4. The FPD 4 detects X-rays from the X-ray tube 3 that transmits through the subject M, and sends detection data at this time to an image generating section 11.

The image generating section 11 images the detection data sent out from the FPD 4, and generates a fluoroscopic imaging P0 having intensity of X-rays being mapped therein. The FPD 4 sends out data to the image generating section 11 in every emission of X-rays from the X-ray tube 3. Accordingly, the image generating section 11 generates two or more fluoroscopic images P0. The fluoroscopic images P0 are obtained while the X-ray tube 3 and the FPD 4 move and rotate. Consequently, the fluoroscopic images P0 each contain fluoroscopic images of the subject M in various perspective directions. The X-ray tube 3 completes emission of X-rays upon one complete rotation of the X-ray tube 3 and the FPD 4 from starting of radiography.

The fluoroscopic imaging P0 is sent out to a tomography-image generating section 12. The tomography-image generating section 12 reconstructs a series of fluoroscopic images P0 having information on three-dimensional configuration of the subject M through imaging in various directions, thereby generating the tomography images P1 in which the subject M with a body axis in the z-direction is cut into round slices. The position cut into round slices varies in the z-direction, whereby two or more tomography images P1 are generated. The tomography image P1 generated in such way is displayed on the display unit 25, and radiography is completed. That is, the tomography images P1 are cross section images when the subject M is cut along a plane where the imaginary circle VC exists and a plane parallel to this. The fluoroscopic images P1 are displayed on the display unit 25 to complete obtaining the fluoroscopic image.

The view field of the first imaging section C1 may fail to cover the total body of the subject M entirely. In this case, as shown in FIG. 10, the fluoroscopic images for the whole body of the subject M may be taken while the subject M is moved in the z-direction.

As above, this example includes the first cylinder 19, the first screws, and the support member 22. The first cylinder 19 has the opening for introducing the support member. The first screws b positions the first cylinder 19. The support member 2 is guided by the first cylinder 19 and supports the movable subject M relative to the first cylinder 19. With such configuration, the support member 2 for supporting the subject M can be moved while being guided. Accordingly, the subject M has a constant position in the vertical direction during movement. In other words, according to the configuration of this example, no deviation in position of the subject M occurs during radiography and thus tomography images can be provided with high visibility and no distortion.

The first cylinder 19 also serves as prevention of the subject M from escaping into the apparatus or for prevention of excrement of the subject M from entering into the apparatus. Consequently, this invention can provide a radiation tomography apparatus with less failure.

As mentioned above, the cylinder 19 has the first rail L1 on the inner wall thereof extending in the z-direction to contact the first rail L1 to the support member 2. Thereby, the support member 2 can be moved on the given track more accurately. The configuration using the first rail L may cause wear of a portion of the support member 2 where the first rail L1 is contacted. In this case, however, the position of the first cylinder 19 can be adjusted finely with use of the screws b. Consequently, no particular problem occurs.

### Example 2

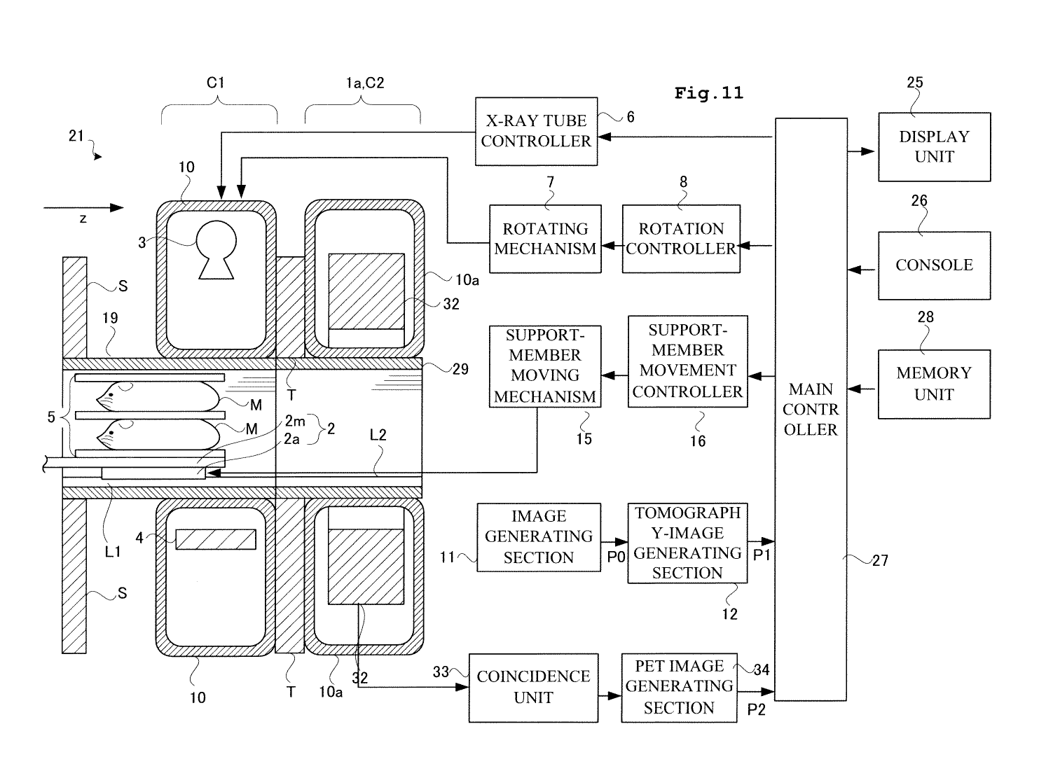

Next, description will be given of a tomography apparatus 21 according to Example 2. The tomography apparatus 21 according to Example 2 includes a positron emission tomography device (PET device) in addition to the apparatus configuration of Example 1, as shown in FIG. 11. Here, in the tomography apparatus 21 according to Example 2, explanation is to be omitted to the same elements as those in the apparatus configuration of Example 1.

The tomography apparatus 21 includes a gantry 10a concerning a PET device 1a besides the gantry 10. The gantry 10a also has a through hole extending in the z-direction into which the support member 2 is inserted. Accordingly, the PET device 1a is provided adjacent to the X-ray tube 3 and the FPD 4 in the z-direction. The PET device 1a is a radiography apparatus for tomography images independent of the above-mentioned first imaging section C1. The PET device 1a is to be referred to as a second imaging section C2. The second imaging section C2 is provided adjacent to the first imaging section C1 in the z-direction. The subject M is introduced into the second imaging section C2 in the z-direction, thereby the second imaging section C2 takes fluoroscopic images of the subject M. Here, the second imaging section C2 corresponds to the second imaging device in this invention.

Both the first imaging section C1 and the second imaging section C2 take fluoroscopic images, but both differ from each other in types of images to be taken. Specifically, the first imaging section C1 generates the fluoroscopic images having easiness of transmitting X-rays in the subject M mapped therein, whereas the second imaging section C2 generates the fluoroscopic images having distribution of the radiopharmaceutical in the subject M mapped therein.

The gantry 10a in the PET device 1a includes inside thereof a detector ring 32 in a ring shape along the contour of the gantry 10a. The detector ring 32 has radiation detectors arranged in a ring shape that can detect gamma-rays.

A coincidence unit 33 is provided for performing coincidence to detection data outputted from the detector ring 32. Detection frequency and detection positions of annihilation gamma-rays pairs simultaneously entering into a portion in the detector ring 32 can be identified with the coincidence unit 33. The coincidence unit 33 outputs results of coincidence to a PET image generating section 34. The PET image generating section 34 calculates generating positions of annihilation gamma-ray pairs in accordance with the detection frequency and the detecting position identified with the coincidence unit 33, thereby generating a PET image P2 having mapped intensity in occurrence of annihilation gamma-ray pairs. The PET image P2 is a tomography image showing distribution of occurrence of annihilation-gamma-rays pairs.

<Regarding Second Cylinder>

Description will be given next of a second cylinder 29 inserted into an opening of the gantry 10a. The second cylinder 29 is a cylindrical member that is provided inside of the gantry 10a and extends in the z-direction, as shown in FIG. 11. The second cylinder 29 having an opening for introducing the support member extending in the z-direction is arranged in a second imaging view field of the second imaging section C2. The subject M is introduced into the second cylinder 29 upon radiography. The second cylinder 29 is provided for preventing the subject M from escaping into the apparatus or for preventing excrement of the subject M from entering into the apparatus. The second cylinder 29 is fixed by a support board T for supporting the second cylinder 29. The support board T is positioned between the gantries 10 and 10a in the z-direction.

The second cylinder 29 has another role besides prevention of the subject M from escaping. That is, the second cylinder 29 also serves as a guide for supporting the subject M upon movement of the support member 2. Specifically, the second cylinder 29 has a second rail L2 on the inner wall thereof that contacts the support member 2 and extends in the z-direction. The support member 2 is guided by the second rail L2 and is movable relative to the second cylinder 29 in the z-direction (i.e., the introduction direction of the subject M.) Consequently, the support member 2 is moved while being guided by the second cylinder 29. The second cylinder 29 has the second rail L2 on the bottom of the inner wall thereof, which configuration is same as that shown in FIG. 2. The second cylinder 29 is composed of an acrylic resin, etc., that is easy to transmit gamma rays. The second cylinder 29 is fixed by the support board T via the screws b, which configuration is similar to that shown in FIG. 3. Likewise, the detailed configuration of the screws b on the second cylinder 29 is same as that shown in FIG. 4. The second cylinder 29 is positioned relative to the support board T via the jig 20 already described with reference to FIG. 5. Actual use of the jig 20 has already been described with FIGS. 6 and 7.

Description will be given next of the second rail L2. The second rail 2 is provided in a position where the first rail L1 extends in the z-direction. Specifically, the rail receiver 2a on the first rail L1 is moved in the z-direction, whereby the rail receiver 2a engages the second rail L2 next as it gradually detaches from the first rail L1. Here, the rail receiver 2a is moved in the z-direction while engaging the second rail L2. In this way, the second rail receiver 2a has a track defined by the second rail L2. The support member 2 is moved in the z-direction relative to the second rail L2 as the rail receiver 2a is moved.

<Regarding Other End of Second Cylinder>

The above only describes one of both ends of the second cylinder 29. Then description will be given of the other end of the second cylinder 29 having not been described yet. The other end corresponds to one ends of the second cylinder 29 on a gantry 10a side. It is referred to as a gantry-side end. The gantry-side end is supported by the gantry 10a via the screws b, which is similar to the configuration described with reference to FIG. 3. The screws b determines the position of the second cylinder 29 relative to the second imaging section C2.

Description will be given of positioning at the gantry-side end. This positioning is performed using the jig 20. Specifically, the gantry 10a is provided with the dowel holes through which the dowel pins h are inserted when the jig 20 is used. The detailed approach of actual positioning has been already described with reference to FIGS. 6 and 7.

<Operation of Tomography Apparatus>

The tomography apparatus 21 may obtain both of the tomography image P1 with X-rays and the PET image P2 with annihilation gamma-ray pairs by one inspection. For generation of both images P1 and P2 with use of the tomography apparatus 21, positron emission type radiopharmaceutical is firstly injected into the subject M. The radiopharmaceutical has a property of concentrating on a specific site portions, such as a lesion of the subject M. The radiopharmaceutical emits a positron. The positron generates an annihilation-gamma-rays pair that travels at a straight angle opposite to each other. Accordingly, an annihilation-gamma-rays pair is to be emitted from the subject M. Since distribution of radiopharmaceutical differs within the subject, the frequency of annihilation-gamma-rays pairs differs in sites of the subject M.

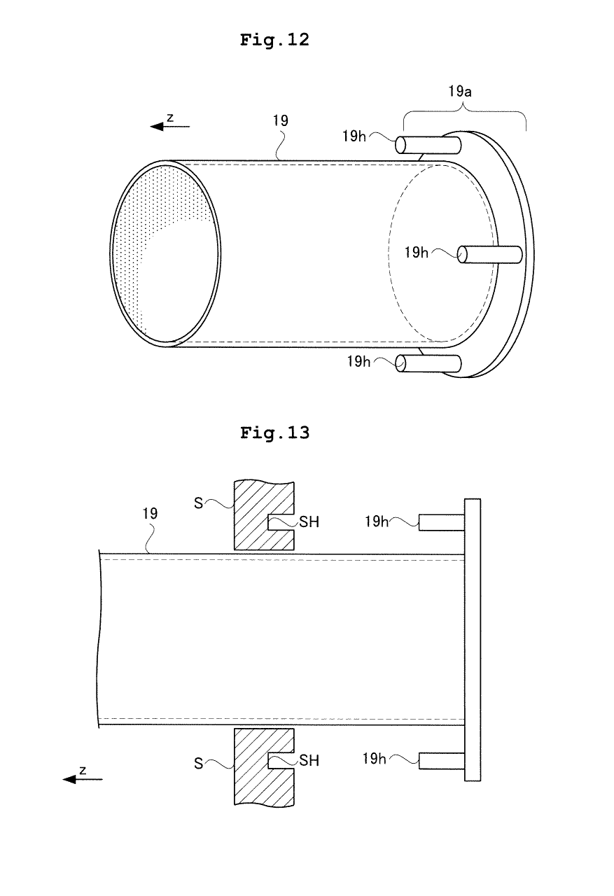

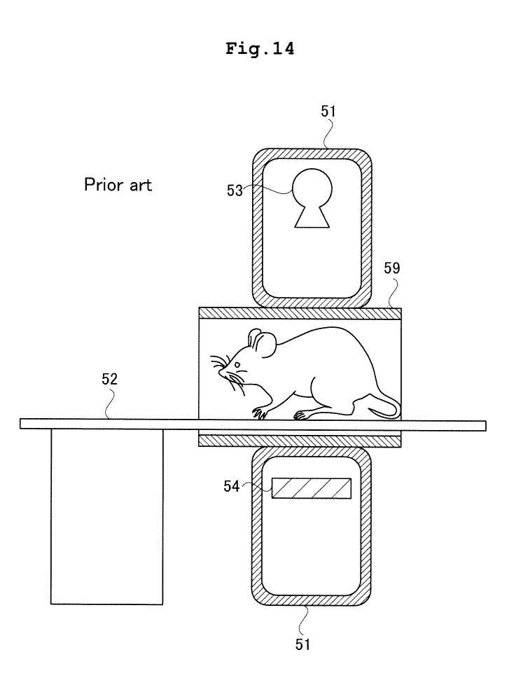

A sufficient time lapses from injection of radiopharmaceutical, and then the subject M is anesthetized and housed into the holder 5. That is, one anesthetized subject M is housed in every opening 5a of the holder 5. Thereafter, the holder 5 having two or more subjects M housed therein is placed on the support member 2. When the experimenter provides instructions via the console 26 to the tomography apparatus 21 to start imaging of PET images, the support member 2 slides to guide the holder 5 into the through hole of the gantry 10a (see FIG. 12.) From this time, the detector ring 32 starts detection of the annihilation-gamma-rays pair, and the PET image generating section 34 generates a PET image P2. The frequency of annihilation-gamma-rays pairs is mapped in the PET image P2 that varies in sites of the subject M. Since distribution of the frequency of annihilation-gamma-rays pairs corresponds to distribution of radiopharmaceutical, the experimenter can recognize distribution of radiopharmaceutical in the subject through diagnosis of the PET image P2. When the view field in the z-direction of the PET device 1a does not entirely cover the total body of the subject M in radiography, the PET image P2 may be imaged while the support member 2 slides in the z-direction.

Following operations are similar to the foregoing radiography operations in Example 1. The tomography image P1, the PET image P2, and a composite image having both the images superimposed are displayed on the display unit 25, and radiography is completed.

As above, the foregoing discloses the configuration in which this invention is applied to an apparatus having two types of tomography apparatus. Examples of such apparatus include a PET/CT apparatus. The foregoing configuration includes the second cylinder 29 having the opening for introducing the support member 2, and the second screws b for positioning the second cylinder 29. In such configuration, the support member 2 is guided by the second cylinder 29. According to the configuration, no deviation in position of the subject M occurs during radiography and thus tomography images can be provided with high visibility and no distortion. The second cylinder 29 also serves as prevention of the subject M from escaping into the apparatus or for prevention of excrement of the subject M from entering into the apparatus. Consequently, this invention can provide a radiation tomography apparatus with less failure.

This invention is not limited to the foregoing configurations, but may be modified as follows:

(1) In the foregoing configurations, the first cylinder 19 and the second cylinder 29 are aligned with the support boards S and T, respectively, via the jig 20. This invention, however, is not limited to this. That is, the cylinders may have no jig 20 on one end thereof. Such modification will be described taking the first cylinder 19 as one example. FIG. 12 shows a first cylinder 19 according to one modification of this invention. The first cylinder 19 has a flange 19a on one end thereof. The flange 19a is ring-shaped that extends in a direction away from the center of the first cylinder 19. The flange 19a has two or more dowel pins h extending in the z-direction on a surface thereof to which the cylinder body is attached.

FIG. 13 shows the first cylinder 19 to be attached to the support board S. The support board S is provided with dowel holes SH into which the dowel pins h of the first cylinder 19 are inserted. The dowel pins h are inserted into the dowel holes SH upon attaching the first cylinder 19 to the support board S, whereby the positional relationship between the first cylinder 19 and the support board S can be determined uniquely. As above, the ring-shaped flange 19a on one end of the cylinder can be used for determination in position of the first cylinder 19. Consequently, the aforementioned configuration can complete positioning of the first cylinder 19 simpler. The configuration that the flange 19a is provided on the end of the cylinder is applicable to the second cylinder 29.

(2) Examples of the CT apparatus and the PET/CT apparatus have been described in the above configurations. This invention is not limited to this configuration. This invention is applicable to a PET device, a MRI apparatus, or the combination thereof.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### DESCRIPTION OF REFERENCES

b . . . screw (positioning device)
C1 . . . first imaging section (first imaging device)
C2 . . . second imaging section (second imaging device)
L1 . . . first rail
L2 . . . second rail
2 . . . support member
3 . . . X-ray tube (radiation source)
4 . . . FPD (detecting device)
6 . . . X-ray tube controller (radiation-source control device)
15 . . . support-member moving mechanism (support-member moving device)
16 . . . support-member movement controller (support-member movement control device)
19 . . . first cylinder
29 . . . second cylinder
32 . . . detector ring

What is claimed is:

1. A radiation tomography apparatus comprising:
a first imaging device for taking tomography images of a subject by introducing the subject in an introduction direction of the subject;
a support member for supporting the subject;
a support-member moving device for moving the support member in the introduction direction of the subject;
a support-member movement controller for controlling the support-member moving device;
a first cylinder provided in a first imaging view field of the first imaging device and having an opening extending in the introduction direction for introducing the support member; and
a first positioning device for positioning the first cylinder relative to the first imaging view field,
the first cylinder guiding the movable support member.

2. The radiation tomography apparatus according to claim 1, further comprising:
a second imaging device provided adjacent to the first imaging device in the introduction direction for taking tomography images of the subject by introducing the subject in the introduction direction;
a second cylinder provided in a second imaging view field the second imaging device and having an opening extending in the introduction direction for introducing the support member; and
a second positioning device for positioning the second cylinder relative to the second imaging view field,
the second cylinder guiding the movable support member.

3. The radiation tomography apparatus according to claim 1, wherein
a position of the cylinder relative to the imaging view field is adjusted by a jig.

4. The radiation tomography apparatus according to claim 1, wherein
the positioning device is formed of screws

5. The radiation tomography apparatus according to claim 1, wherein
the cylinder has a rail on an inner wall thereof that contacts the support member and extends in the introduction direction.

6. The radiation tomography apparatus according to claim 1, wherein
the cylinder has a ring-shaped flange on one end thereof.

7. The radiation tomography apparatus according to claim 1, wherein
the first imaging device includes a radiation source for emitting radiation; a detecting device for detecting the radiation; and a radiation-source controller for controlling the radiation source.

8. The radiation tomography apparatus according to claim 2, wherein
the second imaging device includes a detector ring having radiation detectors being arranged in a ring shape.
